(19) United States
(12) Patent Application Publication
(10) Pub. No.: US 2014/0172712 A1
(43) Pub. Date: Jun. 19, 2014

(54) Transaction Authorisation

(71) Applicants: John Petersen, London (GB); Pat Carroll, London (GB); Jon Alfrod, London (GB)

(72) Inventors: John Petersen, London (GB); Pat Carroll, London (GB); Jon Alfrod, London (GB)

(73) Assignee: VALIDSOFT UK LIMITED, London (GB)

(21) Appl. No.: 14/124,257

(22) PCT Filed: Jun. 7, 2012
(86) PCT No.: PCT/GB2012/051282

§ 371 Date: Mar. 7, 2014

(30) Foreign Application Priority Data
Jun. 7, 2011 (GB) 1109524.7

(51) Int. Cl. G06Q 20/40

(52) U.S. Cl. CPC G06Q 20/4016
USPC 705/44

(57) ABSTRACT

A method for authorising a remote transaction comprises receiving a request to complete a remote transaction from a remote user, for example over the Internet. A telephone number of a telephone, in particular a mobile telephone, associated with the remote user is identified in a database. A subscriber identity associated with the telephone number is requested from a telephone network operator associated with the identified telephone number. The subscriber identity received from the network operator is compared with a stored subscriber identity associated with the remote user. If the received subscriber identity matches the stored subscriber identity authentication information is communicated with the remote user via the telephone. If the received subscriber identity does not match the stored subscriber identity additional identifying information is requested from the remote user. The method has the advantage of preventing fraudulent authorisation of the transaction by a fraudster redirecting the telephone number to their own telephone.

This invention relates to a method for authorising a remote transaction.

### BACKGROUND

Commercial transactions carried out over telecommunications channels, for example the Internet, require reliable authentication of the user requesting the transaction.

In a basic system, the user provides identifying information, such as a username, password and/or personal identification number (PIN) in order to authorise the transaction. However, with the increase in both the volume and sophistication of fraudulent attacks against electronic commerce and in particular Internet banking applications, many banks and other commercial institutions have been forced to adopt greater security protection for online banking websites and similar facilities.

One such method of protection is known as Out-of-Band (OOB) Authentication. This method requires the authentication of the user, and optionally the verification of the transaction content, to be performed on a telecommunications channel (OOB channel) that is different to the electronic channel, for example the Internet, by which the transaction is being requested. The OOB channel is typically a mobile or landline telephone channel, utilising voice, short messaging services (SMS) or some other protocol to provide the authentication information. The authentication is performed automatically by telecommunications software operated by the bank, such as an outbound interactive voice response (IVR) system.

Thus, according to such a system, a user may log on to an online banking website to make a payment to a third party bank account. The user provides a username, password and/or PIN and requests the payment transaction. In order for the transaction to proceed, the user's identity must be verified. The verification process involves a call or message to the user's mobile telephone, the number of which has previously been registered with the bank. Only phone numbers registered with the bank can be selected, which provides a “second factor” in the authentication process, the first factor being the username and password used initially to access the website. The user may be required to provide additional identifying information in response to the call. Typically the process will provide the user with a onetime-pass-code (OTP) with which to complete the transaction.

Fraudsters, in an attempt to compromise this form of strong authentication, use techniques to gain effective control of registered mobile telephones and thus the access to the OTP required for completion of a (fraudulent) online transaction. The fraudsters do this by identifying the Mobile Network Operator (MNO) to which the user subscribes, impersonating the subscriber to the MNO and requesting from the MNO that the phone number be ported from its current Subscriber Identity Module (SIM) to a new SIM that has been acquired by the fraudster. This is the same process that would be performed legitimately if a subscriber changed Mobile Network Operators or lost their existing phone and required a new SIM. The only difference is that the fraudster is, in effect, carrying out the process on behalf of the legitimate user by impersonating that user before the MNO.

Having ported the user's mobile phone number to the fraudster's SIM, a fraudster who has already obtained the user's other credentials, for example his username and/or password can gain access to the user's online banking account, perform a transaction to obtain funds and complete the transaction using the genuine user's mobile phone number. The fraudster simply selects the ported phone number to use for authentication and the authentication call will be received automatically at the fraudster's phone which contains the new SIM and the transaction will be authorised. The genuine user will only be aware of the phone number being ported to another SIM when it is realised that calls and messages are not being received by the user's phone. By this stage, however, the fraud has been perpetrated and the funds stolen.

The present invention, at least in presently preferred embodiments seeks to combat this form of fraud.

### BRIEF SUMMARY OF THE DISCLOSURE

In accordance with the present invention there is provided a method for authorising a remote transaction. The method comprises receiving a request to complete a remote transaction from a remote user and identifying a telephone number of a telephone associated with the remote user in a database. The method further comprises requesting from a telephone network operator associated with the identified telephone number a subscriber identity associated with the telephone number and comparing the subscriber identity received from the network operator with a stored subscriber identity associated with the remote user. If the received subscriber identity matches the stored subscriber identity authentication information is communicated with the remote user via the telephone.

Thus, in accordance with the invention, if a user's telephone number has been associated with a different subscriber identity on the telephone network, for example because of a fraudulent “SIM swap”, this can be identified and the communication of authentication information to the telephone can be suppressed.

If the received subscriber identity does not match the stored subscriber identity, the method may comprise rejecting the request for authorisation. However, in a presently preferred embodiment, if the received subscriber identity does not match the stored subscriber identity the method comprises requesting additional identifying information from the remote user. Requesting additional identifying information from the remote user may comprise placing a telephone call to the telephone to request input from the remote user. Input may be requested manually, for example by means of an operator conversing with the remote user. Alternatively, the input may be requested automatically, for example by means of a touch tone response or automated voice recognition system. The additional identifying information may comprise, for example, name, date of birth, address, bank account or credit card number, an answer to a predetermined security question and/or a PIN number or password. Typically, requesting additional identifying information from the remote user includes confirming with the remote user that the subscriber identity associated with the telephone has changed legitimately.

The method may further comprise, after receiving correct identifying information from the remote user, storing the subscriber identity received from the telephone network operator in a database and associating the received subscriber identity with the remote user in the database. The received subscriber identity may be associated with the remote user and/or the telephone number in the database. Multiple telephone numbers may be associated with a particular user in the database. Each telephone number will be associated with a respective subscriber identity.

Typically, the request to complete a remote transaction is received over the Internet. However, the method of the invention is of application where the request is received by other means, for example over a private data network, in person or by fax.

Typically, the telephone is a mobile telephone. However, the invention is also of application where the telephone is a landline (ISDN) telephone. In this case, the subscriber identity may be an address or telephone account number, for example. The invention is also of application where the telephone is a VoIP telephone. In this case, the subscriber identity may be an IP address, for example.

In the case of a mobile telephone, the subscriber identity may be an International Mobile Subscriber Identity (IMSI), an Integrated Circuit Card ID (ICCID) or equivalent unique Subscriber Identity. Module (SIM) identifier. Alternatively or in addition, the subscriber identity may be a handset identifier.

In embodiments of the invention, communicating authentication information with the remote user comprises sending a message to the telephone. The message may be sent via the Short Message Service (SMS). The message may include an authorisation code for completion of the transaction. The authorisation code may be a one-time authorisation code specific to the transaction. Alternatively or in addition, the message may request input from the remote user, for example by means of a reply message.

Alternatively or in addition, communicating authentication information with the remote user may comprise placing a telephone call to the telephone to request input from the remote user. Input may be requested manually, for example by means of an operator conversing with the remote user. Alternatively, the input may be requested automatically, for example by means of a touch tone response or automated voice recognition system. The requested input may relate to the user and/or may relate to the transaction, for example amount, date, payee or the like.

Alternatively or in addition, communicating authentication information with the remote user may comprise receiving a telephone call from the telephone, for example to provide input from the remote user. Input may be provided manually, for example by means of an operator conversing with the remote user. Alternatively, the input may be provided automatically, for example by means of a touch tone response or automated voice recognition system. The requested input may relate to the user and/or may relate to the transaction, for example amount, date, payee or the like.

In a further embodiment according to the invention, there is provided a method for evaluating a remote transaction for the likelihood of fraud. The method comprises receiving, from a transaction processing system, a request to evaluate a first remote transaction which is being carried out between the transaction processing system and a remote user. The method further comprises identifying a telephone number of a telephone associated with the remote user in a database; requesting from a telephone network operator associated with the identified telephone number a subscriber identity associated with the telephone number; comparing the subscriber identity received from the network operator with a primary stored subscriber identity associated with the remote user; assigning a value to the first remote transaction, the value depending at least in part on whether the received subscriber identity matches the primary stored subscriber identity; and communicating the value to the transaction processing system.

Thus, in accordance with the invention, if a transaction processing system has reason to suspect a fraudulent transaction, it can initiate an evaluation. Then, if a user's telephone number has been associated with a different subscriber identity on the telephone network, for example because of a fraudulent “SIM swap”, this can be identified and communicated to the transaction processing system. The transaction processing system can then decide whether the communication of authentication information to the telephone should be suppressed.

The value may only indicate whether the SIM has been changed, for example the value may comprise “SIM change” or “SIM match”. However the value may also contain additional information. The value may also comprise a score such as a percentage, giving an indication of the likelihood of a fraudulent SIM swap.

If the received subscriber identity does not match the primary stored subscriber identity, the method may comprise requesting additional identifying information from the remote user. Requesting additional identifying information from the remote user may comprise placing a telephone call to the telephone to request input from the remote user. Input may be requested manually, for example by means of an operator conversing with the remote user. Alternatively, the input may be requested automatically, for example by means of a touch tone response or automated voice recognition system. The additional identifying information may comprise, for example, name, date of birth, address, bank account or credit card number, an answer to a predetermined security question and/or a PIN number or password. Typically, requesting additional identifying information from the remote user includes confirming with the remote user that the subscriber identity associated with the telephone has changed legitimately.

The method may further comprise, after receiving correct identifying information from the remote user, storing the subscriber identity received from the telephone network operator in a database and associating the received subscriber identity with the remote user in the database. The received subscriber identity may be associated with the remote user and/or the telephone number in the database. Multiple telephone numbers may be associated with a particular user in the database. Each telephone number will be associated with a respective subscriber identity.

Typically, a request to complete the first remote transaction is communicated by the remote user to the transaction processing system over the Internet. However, the method of the invention is of application where the request is received by other means, for example over a private data network, in person or by fax.

Typically, the telephone is a mobile telephone. However, the invention is also of application where the telephone is a landline (ISDN) telephone. In this case, the subscriber identity may be an address or telephone account number, for example. The invention is also of application where the telephone is a VoIP telephone. In this case, the subscriber identity may be an IP address, for example.

In the case of a mobile telephone, the subscriber identity may be an International Mobile Subscriber Identity (IMSI), an Integrated Circuit Card ID (ICCID) or equivalent unique Subscriber Identity Module (SIM) identifier. Alternatively or in addition, the subscriber identity may be a handset identifier.

It may be that the method further comprises the transaction processing system communicating authentication information with the remote user via the telephone if the transaction is determined not to be fraudulent. Typically, the transaction processing system will communicate authentication information with the remote user via the telephone if the received subscriber identity matches the primary stored subscriber identity.

In embodiments of the invention, communicating authentication information with the remote user comprises sending a message to the telephone. The message may be sent via the Short Message Service (SMS). The message may include an authorisation code for completion of the transaction. The authorisation code may be a one-time authorisation code specific to the transaction. Alternatively or in addition, the message may request input from the remote user, for example by means of a reply message.

Alternatively or in addition, communicating authentication information with the remote user may comprise placing a telephone call to the telephone to request input from the remote user. Input may be requested manually, for example by means of an operator conversing with the remote user. Alternatively, the input may be requested automatically, for example by means of a touch tone response or automated voice recognition system. The requested input may relate to the user and/or may relate to the transaction, for example amount, date, payee or the like.

Alternatively or in addition, communicating authentication information with the remote user may comprise receiving a telephone call from the telephone, for example to provide input from the remote user. Input may be provided manually, for example by means of an operator conversing with the remote user. Alternatively, the input may be provided automatically, for example by means of a touch tone response or automated voice recognition system. The requested input may relate to the user and/or may relate to the transaction, for example amount, date, payee or the like.

Typically, the method further comprises analysing further information associated with the telephone, the value depending at least in part on the analysis. Any information which can be requested from the phone, or which is received as part of ordinary communications with the phone, can be used as part of the analysis.

It may be that the analysis comprises comparing the network associated with received subscriber identity with the network associated with the primary stored subscriber identity. The analysis may comprise comparing current information about the phone, such as the identity and versions of the software being used or the make and model of the phone, with stored information associated with the remote user.

Typically, the method further comprises storing the received subscriber identity as a secondary stored subscriber identity in a database, and associating the secondary stored subscriber identity with the user and the time at which the transaction was requested in the database, if the received subscriber identity does not match the primary stored subscriber identity.

Where a secondary stored subscriber identity is stored, the method may further comprise: receiving, from a transaction processing system, a request to evaluate a second remote transaction which is being carried out between the transaction processing system and the remote user; identifying a telephone number of a telephone associated with the remote user in a database; requesting from a telephone network operator associated with the identified telephone number a subscriber identity associated with the telephone number; comparing the subscriber identity received from the network operator with the secondary stored subscriber identity; and replacing the primary stored subscriber identity with the secondary stored subscriber identity if the received subscriber identity matches the secondary stored subscriber identity, and if a predetermined period of time has passed since the first remote transaction.

Alternatively or in addition, the method may further comprise removing the secondary stored subscriber identity from the database if the received subscriber identity does not match the secondary stored subscriber identity. Removing the secondary stored subscriber identity from the database may comprise deleting the secondary stored subscriber identity. Alternatively the secondary stored subscriber identity may be marked within the database so that it will be ignored in future comparisons. The secondary stored subscriber identity may also be added to a blacklist of subscriber identities, such that the blacklist can then be used to help determine which transactions should be refused.

In a preferred embodiment, at least one stored subscriber identity is not unique to the user. For example, a stored subscriber identity may be a fraction of the subscriber identity received from the network operator. Alternatively or in addition, a stored subscriber identity may be encrypted using a transformation which produces a non-unique result.

Where the received subscriber identity does not match the primary stored subscriber identity, the value assigned to the first remote transaction may be determined by additional information relating to the remote user. In this way, where a fraudulent SIM swap appears to have taken place, a “false positive” can be avoided by using other information to confirm the authenticity of the remote user. The additional information may include information relating to an Internet connection and/or browser by means of which the remote user has requested the first remote transaction. For example, the additional information may include the IP address of the remote user and/or a browser “fingerprint”. The additional information may be compared to stored corresponding information for that user. The additional information may include information relating to the location of the telephone associated with the remote user. For example, the additional information may include the current cell or sector in which a mobile telephone associated with the remote user is located. The cell or sector may be compared to a stored cell or sector associated with that user. Typically, most banking transactions are carried out by users from a limited number of locations, such as home or work. The cells associated with these locations can be stored in a database and compared to the results of an HLR look up.

The invention extends to a data processing system configured to carry out the methods of the invention described above. The invention also extends to computer software which configures a general-purpose data processing system to carry out the methods.

### BRIEF DESCRIPTION OF THE DRAWINGS

Embodiments of the invention are further described hereinafter with reference to the accompanying drawings, in which:

FIG. 1 is a schematic representation of a data processing system for carrying out the method of the invention;

FIG. 2 is a flow diagram illustrating a process according to an embodiment of the invention;

FIG. 3 shows a second data processing system for authorising a remote transaction according to an embodiment of the invention; and

FIG. 4 is a table showing an example of an entry in an IMSI/ICCID database.

### DETAILED DESCRIPTION

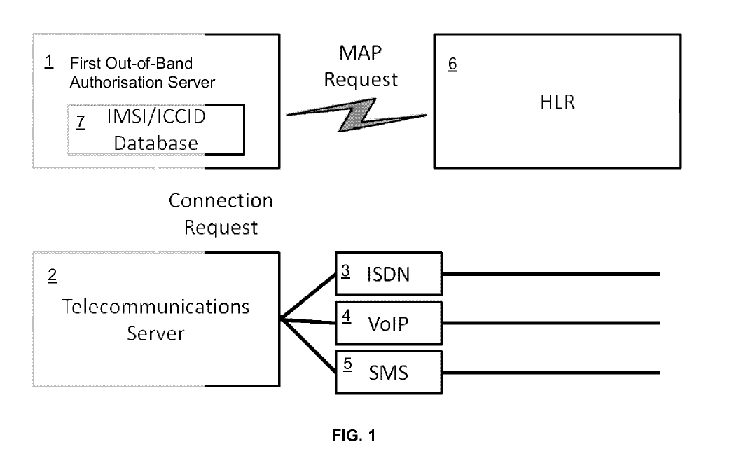

Referring to FIG. 1 a first data processing system for authorising a remote transaction comprises a first Out-Of-Band Authorisation Server 1. The first authorisation server 1 is in data communication with a telecommunications server 2 via which the first authorisation server is able to send messages or initiate telephone calls with remote user telephones (not shown). The telecommunications server 2 may be capable of communicating over a plurality of channels, for example Integrated Services Digital Network (ISDN) 3 or Voice over Internet Protocol (VoIP) 4 for audio calls or Short Message Service (SMS) 5 for messages. It is not necessary for the telecommunications server 2 to have access to all of these channels. For example, the telecommunications server 2 may be arranged to communicate only via SMS 5. The telecommunications server 2 controls the actual connection to the user's telephone. This includes connecting and disconnecting the call, playing voice scripts, recognising Dual-Tone Multi-Frequency (DTMF) replies, potentially passing voice responses to speech recognition or voice verification services and communicating such responses back to the first authorisation server for action.

The first authorisation server 1 is also in data communication with the Home Location Register (HLR) 6 of a Mobile Network Operator (MNO). The HLR is a central database that contains details of each mobile phone subscriber that is authorised to use the mobile network. For each network subscriber the HLR stores a unique identifier, such as an IMSI or ICCID, against the Mobile Services ISDN (MSISDN) number, i.e. the telephone number, for that subscriber. The unique identifier is used to identify the subscriber on the network and to route calls, messages and data to that subscriber. Typically, a unique identifier is associated with a Subscriber Identity Module (SIM) as opposed to a device, and is usually a smart card that can be inserted into a mobile telephone or other mobile device, for example a Personal Digital Assistant (PDA), in order to identify that mobile telephone or device on the mobile network.

When a user initially subscribes to a mobile network, the user receives a SIM and a telephone number and the user's SIM unique identifier and MSISDN are stored as a pairing in the HLR of the MNO. In the event that the subscriber wishes to change the SIM Unique Identifier associated with the MSIDN, for example because the SIM has been lost or broken or the user wishes to subscribe to a different MNO, the user can request the MSISDN be “ported”. In this case, the MSISDN will be associated with the new SIM Unique Identifier in an HLR, which may be the HLR of the same MNO or the HLR of a different MNO. In some countries, an MSISDN can be “ported” within minutes. The porting process will usually require the user to provide secure identifying information in order to authorise the transfer. In the event that a fraudster can impersonate a legitimate subscriber and provide this secure identifying information, the fraudster can port the MSISDN of the subscriber to a SIM in the possession of the fraudster. In this case, the fraudster is able to send and receive calls and messages using the subscriber's telephone number. This has potentially serious security implications for online transactions that use OOB authorisation.

In order to combat the potential fraud whereby a fraudster ports a legitimate user's mobile telephone number to the fraudster's mobile telephone, the first Out-of-Band Authorisation Server 1 of FIG. 1 includes an IMSI/ICCID database 7, which stores the SIM unique identifier for each registered user of the authorisation service. The IMSI/ICCID database 7 may also store information such as the MNO which the mobile phone subscribes to, the software used on the phone, and the make and model of the phone, where such information is available. When a new user registers with the first authorisation server 1 and provides a mobile telephone number with which to authorise subsequent transactions, the first authorisation server 1 sends a Mobile Application Part (MAP) request to the HLR 6 in order to obtain the SIM unique identifier associated with the provided mobile telephone number. The received SIM unique identifier is stored in the IMSI/ICCID database 7 against the mobile telephone number of the registered user. Any storage of data, such as MSISDN, IMSI and ICCID, may be performed using the highest and latest available encryption and hashing techniques.

Subsequently, when it is necessary to authorise a transaction for a registered user, the first authorisation server identifies the mobile telephone number with which it is proposed to carry out the authorisation and sends a MAP request to the HLR 6 to obtain the SIM Unique Identifier associated with that mobile telephone number. This request is performed before any attempt is made to connect to the mobile telephone and is not reliant on ISDN signalling of any type. The first authorisation server 1 then compares the received SIM Unique Identifier to the SIM Unique Identifier stored in the IMSI/ICCID database 7 for that mobile telephone number. If the stored SIM Unique Identifier matches the received SIM Unique Identifier, the authorisation process continues by communicating with the mobile telephone, for example by means of an automated telephone call or short message. The SIM Unique Identifier comparison may also be carried out even if the particular mobile telephone is not to be used for authorisation. If the received SIM Unique Identifier does not match the stored SIM Unique Identifier, the first authorisation server 1 identifies that the mobile telephone number has been ported to a new SIM, which may be the result of fraudulent activity. In this case, the authorisation process is carried out manually by means of an operative telephoning the mobile telephone number to seek additional identifying information from the purported user and to confirm that the telephone number has been ported legitimately. If the user is successfully identified, the new received SIM Unique Identifier is stored in the IMSI/ICCID database 7 for future reference.

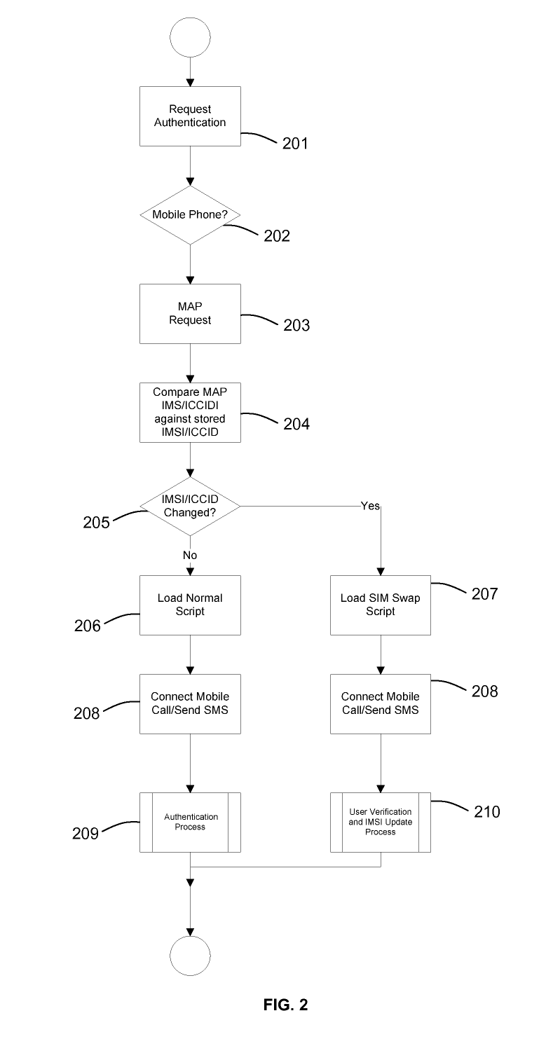

FIG. 2 shows a process for operating the first authorisation server 1 in accordance with a first embodiment of the invention. The process begins at step 201 with a request to the first authorisation server 1 for authentication from an Internet banking application or similar transaction processing system. At step 202, the first authorisation server 1 checks whether any of the registered authentication devices are mobile telephones. If so, at step 203, the first authorisation server 1 performs an HLR MAP request for each registered mobile phone to obtain the SIM Unique Identifier associated with each mobile telephone number. At step 204, the first authorisation server compares the SIM Unique Identifier received from the HLR 6 to the SIM Unique Identifier stored in the IMSI/ICCID database 7 of the first authorisation server 1 for the respective mobile telephone, i.e. the SIM Unique Identifier that was stored the last time the mobile phone number was used for authentication purposes. On the basis of the SIM Unique Identifier comparison, at step 205, the first authorisation server 1 selects one of two possible scripts to continue the authentication process.

If the SIM Unique Identifier for the mobile telephone has not changed since the last time the mobile phone was used for authorisation, the normal processing script is loaded at step 206. If the SIM Unique Identifier for the mobile telephone has changed since the last time the mobile phone was used for authorisation, the SIM swap processing script is loaded at step 207. In either case, the next step 208 is for the authentication server 1 to connect a mobile call or send an SMS to the mobile telephone by means of the telecommunications server 2. The difference between the normal processing script and the SIM Swap processing script is the latter simply connects the call (or sends an SMS), but does not allow the authentication to proceed. According to the normal processing script, the authentication process at step 209 involves sending a unique, one-time authorisation code to the user via telephone call or SMS for the user to input the authorisation code in the Internet banking application in order to authorise the transaction.

In accordance with the SIM Swap processing script, a user verification step 210 is carried out, either manually or automatically, to confirm that the change of SIM Unique Identifier was legitimately requested by the genuine user and, if so, to update the stored IMSI in the IMSI/ICCID database 7 with the new SIM Unique Identifier. If the verification step 210 is carried out successfully, an authorisation code may be sent to the user as in the normal processing script.

The SIM swap script 207 may also comprise the step of analysing further information associated with the telephone. What information is available will vary dependent upon the phone and the network, but the first authorisation server 1 may be able to determine the mobile network operator which the phone subscribes to, the software being used on the phone, and the phone's make and model number, and compare this information to similar information stored in the IMSI/ICCID database 7. The first authorisation server can then make a score based assessment of the phone, and decide whether it is necessary to continue to step 210, or whether to proceed to step 209 instead.

If the phone's software, make or model number have not changed, this may indicate that the user has changed their SIM but kept their phone and telephone number, for example because the original SIM was damaged, and so indicate that a fraudulent SIM swap has not taken place.

Typically, a fraudulent SIM swap occurs within a single network, as this allows the SIM swap to occur more quickly. Hence, in contrast, a change in SIM which occurs within a single network is more likely to be fraudulent than a change in SIM which is accompanied by a change in network. Consequently, where the SIM Unique Identifier has changed and the new Identifier is associated with a different network to the original network this information may be used to identify that the change of Identifier is not fraudulent.

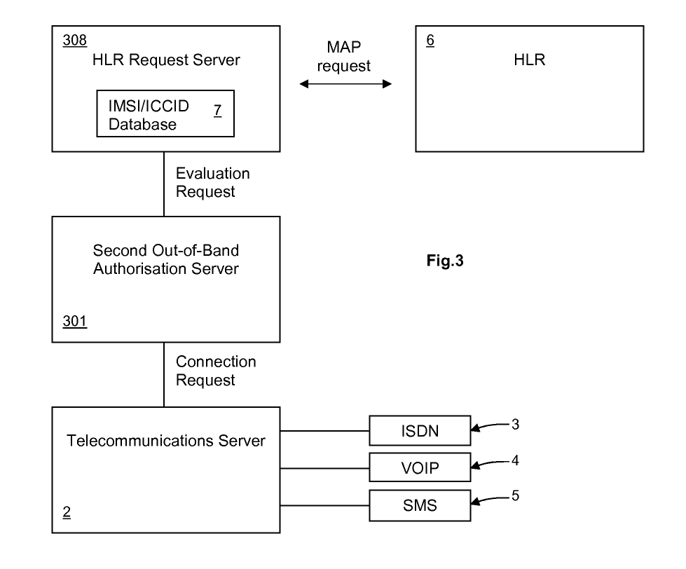

FIG. 3 shows a second data processing system for authorising a remote transaction. The second data processing system is similar to the first data processing system except that the second data processing system comprises a second Out-of-band authorisation server 301 and an HLR request server 308. Working together, the second authorisation server 301 and the HLR request server 308 fulfil the same role as the first authorisation server 1 in the first data processing system.

When the second authorisation server 301 receives a connection request, it first decides whether to make an evaluation request to the HLR request server 308. This decision may be based on factors such as the nature and location of the connection request, in light of recorded data such as past activity by the user making the connection request. If the second authorisation server 301 decides that further evaluation is needed, it can make an evaluation request to the HLR request server 308.

When the HLR request server 308 receives an evaluation request, it performs an HLR MAP request and compares the results with stored data on the IMSI/ICCID database 7 as is described above with reference to the first data processing system. However, the HLR request server 308 does not directly authorise the connection request. Instead, the HLR request server returns results to the second authorisation server 301. The second authorisation sever 301 can then perform further evaluation or contact the user as appropriate.

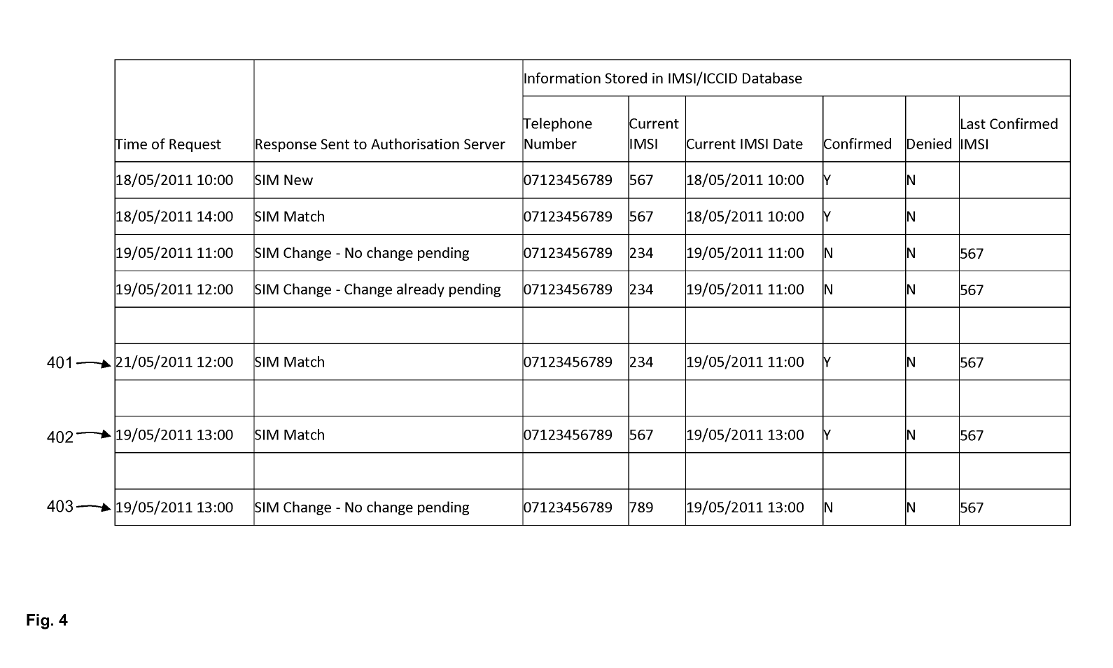

FIG. 4 is a table showing an example of how an entry in an IMSI/ICCID database 7 can change with time. In the table, a first evaluation request is sent by the second authorisation server 301 at 10 am 18 May 2011. Before this time the IMSI/ICCID database has no record of the user, so a new entry is created in the database. The record includes the telephone number, the IMSI, and the date and time at which the IMSI was recorded. The HLR request server 308 sends a response of “SIM new” to the second authorisation server 301, indicating that the SIM is new, and that no previous SIM has been recorded for this telephone number. In this case, the transaction is confirmed by the bank which administers the transaction, so this is recorded in the confirmed column. There is also a denied column, in case the transaction is denied.

Only a fragment of the IMSI is recorded. With only a partial IMSI, the intrusion of the database into a user's privacy is minimised. However, a partial IMSI is still useful in establishing whether a SIM has been changed since, even if the partial IMSI is not unique to one SIM, it will still only apply to a subset of SIMs. Hence the HLR request server 308 can still tell when the SIM has changed except on those occasions when the SIM has been changed to a SIM with an identical partial IMSI.

When a second transaction occurs at 2 pm on 18 May 2011, with the same telephone number and IMSI, the HLR request server 308 returns a result of “SIM match”, and the IMSI/ICCID database entry is left unchanged.

When a third transaction occurs at 11 am on 19 May 2011, the telephone number is the same but the IMSI has changed. Therefore the HLR request server returns a result of “SIM Change—No change pending”, indicating that the IMSI has changed, and that this is the first time the new IMSI has been seen. The database entry is also changed. The original partial IMSI (567) is recorded as the last confirmed IMSI, and the current partial IMSI (234) is also recorded. The current IMSI date is also updated to match the time of the third transaction, the time at which the second data processing system became aware of the change in SIM. As the IMSI is not confirmed, the confirmed column is updated to reflect this.

When a fourth transaction occurs at 12 pm on 19 May 2011, the partial IMSI is still 234. Therefore the database is not updated, and the HLR request server 308 returns a result of “SIM Change—Change already pending” to indicate that the change in the IMSI is known, but has not yet been confirmed.

What happens next depends upon the time and the nature of the next transaction. Lines 401, 402 and 403 indicate different possible fifth transactions, and their effect upon the IMSI/ICCID database.

Line 401 shows a transaction which occurs at 12 pm on 21 May 2011. At this point, it is more than 48 hours since the time recorded as the current IMSI date, and the IMSI has not changed further. As SIM swapping interferes with the operation of a user's phone, the user is likely to notice the swap within 48 hours. Therefore any partial IMSI which persists for more than 48 hours is treated as confirmed. Therefore the confirmed column is updated and the HLR request server 308 returns a result of “SIM Match”.

Line 402 shows a transaction which occurs at 1 pm on 19 May 2011. In this case, the IMSI changes back to 567. This may indicate that a SIM swap occurred and was fixed, or that a mistake was made. In either case, the database is updated to show the current IMSI as 567, with an IMSI date of 1 pm on 19 May 2011, the time of the fifth transaction, and the IMSI is recorded as confirmed again. The HLR request server 308 returns a result of “SIM Match”.

Line 403 shows a transaction which occurs at 1 pm on 19 May 2011. In this case, the IMSI changes again, to 789. Therefore 789 is recorded as the current IMSI, with a current IMSI date of 1 pm on 19 May 2011, the time of the fifth transaction. This IMSI is not confirmed and, since the IMSI 234 was never confirmed, the last confirmed IMSI remains 567. The HLR request server 308 returns a result of “SIM change—No change pending”.

In broad terms, the invention relates to SIM Swap (Number Porting) detection of a mobile telephone using a Home Location Register (HLR) to protect mobile telephone based strong authentication systems from fraudulent misuse.

In summary, a method for authorising a remote transaction comprises receiving a request to complete a remote transaction from a remote user, for example over the Internet. A telephone number of a telephone, in particular a mobile telephone, associated with the remote user is identified in a database. A subscriber identity associated with the telephone number is requested from a telephone network operator associated with the identified telephone number. The subscriber identity received from the network operator is compared with a stored subscriber identity associated with the remote user. If the received subscriber identity matches the stored subscriber identity authentication information is communicated with the remote user via the telephone. If the received subscriber identity does not match the stored subscriber identity additional identifying information is requested from the remote user. The method has the advantage of preventing fraudulent authorisation of the transaction by a fraudster redirecting the telephone number to their own telephone.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for evaluating a remote transaction for the likelihood of fraud in an out-of-band authentication system in which a transaction processing system receives, from a remote user, a request to complete a first remote transaction over the Internet, the method comprising:
receiving, from-a the transaction processing system, a request to evaluate-a the first remote transaction;
identifying a telephone number of a telephone associated with the remote user in a database;
requesting, from a telephone network operator associated with the identified telephone number, a subscriber identity associated with the identified telephone number;
comparing the subscriber identity received from the telephone network operator with a primary stored subscriber identity associated with the remote user;
assigning a value to the first remote transaction, the value depending at least in part on whether the received subscriber identity matches the primary stored subscriber identity; and
communicating the value to the transaction processing system such that the transaction processing system can communicate authentication information with the remote user via a telephone call to the telephone or a message sent to the telephone depending upon the assigned value.

2. The method of claim 1, further comprising:
if the received subscriber identity does not match the primary stored subscriber identity, requesting additional identifying information from the remote user via the telephone; and
if correct additional identifying information is received from the remote user, storing the subscriber identity received from the telephone network operator in a database and associating the received subscriber identity with the remote user in the database,
wherein requesting additional identifying information from the remote user comprises placing a telephone call to the telephone or sending a message to the telephone to request input from the remote user.

3. (canceled)

4. The method of claim 2, wherein requesting additional identifying information from the remote user includes confirming with the remote user that the subscriber identity associated with the identified telephone number has changed legitimately.

5. (canceled)

6. (canceled)

7. The method of claim 1, wherein the telephone is a mobile telephone, and
wherein the subscriber identity is an International Mobile Subscriber Identity (IMSI), and Integrated Circuit Card ID (ICCID) or an identifier of the mobile telephone handset.

8. (canceled)

9. (canceled)

10. (canceled)

11. (canceled)

12. The method of claim 1, wherein communicating authentication information with the remote user comprises sending an authorisation code for completion of the transaction.

13. The method of claim 1, wherein communicating authentication information with the remote user comprises requesting input from the remote user.

14. The method of claim 1, further comprising:
analysing further information associated with the telephone, the value depending at least in part on the analysis,
wherein the analysis comprises comparing the network associated with received subscriber identity with the network associated with the primary stored subscriber identity.

15. (canceled)

16. The method of claim 1, further comprising:
if the received subscriber identity does not match the primary stored subscriber identity, storing the received subscriber identity as a secondary stored subscriber identity in a database and associating the secondary stored subscriber identity with the remote user and the time at which the transaction was requested in the database.

17. The method of claim 16, further comprising:
receiving a request to complete a second remote transaction over the Internet which is being carried out between the transaction processing system and the remote user;
requesting from the telephone network operator associated with the identified telephone number a second subscriber identity associated with the telephone number;
comparing the second subscriber identity received from the telephone network operator with the secondary stored subscriber identity; and
replacing the primary stored subscriber identity with the secondary stored subscriber identity if the received second subscriber identity matches the secondary stored subscriber identity, and if a predetermined period of time has passed since the first remote transaction.

18. The method of claim 17, further comprising:
removing the secondary stored subscriber identity from the database if the received subscriber identity does not match the secondary stored subscriber identity.

19. The method of claim 1, wherein at least one stored subscriber identity is not unique to the user.

20. The method of claim 19, wherein a stored subscriber identity is a fraction of the subscriber identity received from the telephone network operator.

21. The method of claim 1, wherein, if the received subscriber identity does not match the primary stored subscriber identity, the value assigned to the first remote transaction is determined by additional information relating to the remote user, and wherein the additional information includes:
information relating to an Internet connection and/or browser by means of which the remote user has requested the first remote transaction; and/or
information relating to the location of the telephone associated with the remote user.

22. (canceled)

23. (canceled)

24. A data processing system configured to carry out the method of claim 1.

25. A computer program product comprising a computer-readable storage medium having computer-readable program code embodied therein, wherein the computer-readable program code, when executed by general-purpose data processing system, causes the general-purpose data processing system to carry out the method of claim 1.
